(19) United States
(12) Patent Application Publication
(10) Pub. No.: US 2004/0225676 A1
(43) Pub. Date: Nov. 11, 2004

(54) Site epuipment survey tool

(76) Inventors: Daniel T. Johnson, Medina, MN (US); James W. Peterson, Lake Elmo, MN (US); Robert S. McConnell, Woodbury, MN (US)

Correspondence Address: Sean D. Solberg, DORSEY & WHITNEY LLP, Suite 1500, 50 South Sixth Street, Minneapolis, MN, 55402-1498, US

(21) Appl. No.: 10/771,090

(22) Filed: Feb. 3, 2004

Related U.S. Application Data
(60) Provisional application No. 60/444,437, filed on Feb. 3, 2003.

(51) Int. Cl. G06F 7/00

(52) U.S. Cl. 707/102

(57) ABSTRACT

A method for surveying equipment assets located at a site or at multiple distributed sites. The method can include gathering and compiling any legacy data relating to equipment at a site. Based on this legacy data and the goals and objectives of the enterprise, an equipment asset data structure is created and the legacy data is converted into this structure. This data structure, including the legacy data, is then communicated to a mobile survey device. An operator then uses the mobile survey device to survey the equipment assets located at a site.

### CROSS-REFERENCE TO RELATED APPLICATION(S)

This application claims priority from U.S. provisional application No. 60/444,437, filed Feb. 3, 2003, which is hereby incorporated by reference in its entirety.

### FIELD OF THE INVENTION

The present invention relates to systems and methods of collecting information related to physical objects, equipment, and infrastructure at one or more sites. More specifically, it relates to a system for tagging and collecting virtually unlimited information about a site and about equipment assets located at the site.

### BACKGROUND OF THE INVENTION

The overall cost of equipment assets located at a site is typically a significant and ever increasing operating expense faced by large sites or facilities, such as government, commercial retailers, and industrial facilities (collectively “sites”). Management of sites and tracking the overall cost of equipment assets at the site is a difficult and time-consuming task and is even more difficult for an enterprise including multiple facilities or sites distributed throughout a large geographic region. For example, a large retail chain having sites distributed at locations throughout the United States may have hundreds of locations each requiring independent monitoring and evaluation. Located within these hundreds of locations may be tens of thousands of pieces of equipment assets, which contribute to the overall operating cost of its site and of the retail chain enterprise. Each year, enterprises lose profits due to their inability to effectively track equipment assets.

The overall cost of each individual asset is difficult to track, because of the enormous volume of equipment assets located throughout a distributed enterprise. Moreover, the overall cost is a combination of a number of factors, such as for example, initial purchase costs, maintenance and repair costs, and energy consumption costs. Enterprises currently lack the ability to effectively manage and track these assets and to associate various ancillary costs with the asset to enable computation of an overall cost of the equipment asset. Enterprises further lack the ability to take an inventory or survey of its equipment assets located at various distributed sites and to collect and organize information relating to those assets.

Accordingly, there is a need in the art for a system or method for surveying equipment assets located at one or more sites. There is a further need for a system and method for quickly and effectively collecting information relating to equipment assets of an enterprise.

### BRIEF SUMMARY OF THE INVENTION

The present invention, in another embodiment, is a method for surveying equipment assets located at a site or at multiple distributed sites. The method includes gathering and compiling any legacy data relating to equipment at a site. Based on this legacy data and the goals and objectives of the enterprise, an equipment asset data structure is created and the legacy data is converted into this structure. This data structure, including the legacy data, is then communicated to a mobile survey device. An operator then uses the mobile survey device to survey the equipment assets located at a site. In one embodiment, quality control is performed on the survey data to ensure accuracy.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a flow chart showing a method for surveying equipment at a site, according to one embodiment of the present invention.

FIG. 1A is a diagram depicting exemplary information collected for various types of equipment, according to one embodiment of the present invention.

FIG. 1B is a diagram depicting exemplary information collected for various types of equipment, according to a further embodiment of the present invention.

FIG. 2 is a flowchart showing an equipment surveying method using a mobile survey device, according to one embodiment of the present invention.

FIGS. 2A-9 are exemplary screen shots showing portions of a mobile survey device, according to one embodiment of the present invention.

FIG. 10 is a schematic diagram illustrating an equipment asset survey system, according to an additional embodiment of the present invention.

FIG. 11 is a schematic diagram showing an equipment asset survey system, according to a further embodiment of the present invention.

FIG. 12 is a flowchart depicting a method of creating a data structure, according to one embodiment of the present invention.

FIG. 13 is a flowchart illustrating a method of defining survey objectives, according to one embodiment of the present invention.

FIG. 14 is a flowchart showing a method of creating normalized lists of expected information, according to one embodiment of the present invention.

FIG. 15 is a flowchart depicting a method of allowing for data structure adjustment during the survey process, according to one embodiment of the present invention.

FIG. 16 is a flowchart illustrating a method of conducting a survey relating to data associated with refrigeration or HVAC assets for the purposes of refrigerant tracking, according to one embodiment of the present invention.

FIG. 17 is an exemplary representation of a form that can be used for manual collection of data related to refrigeration or HVAC assets, according to one embodiment of the present invention.

FIG. 18 is a flowchart showing a method of conducting a survey relating to data associated with refrigerant stored in cylinders at a site for the purposes of refrigerant tracking, according to one embodiment of the present invention.

FIG. 19 is an exemplary representation of a form that can be used for manual collection of data related to stored refrigerant, according to one embodiment of the present invention.

FIG. 20 is a flowchart illustrating a method of conducting a survey relating to refrigerant leakage and repair data associated with refrigeration or HVAC assets, according to one embodiment of the present invention.

FIG. 21 is an exemplary representation of a form that can be used for manual collection of data related to leakage and repair of refrigeration or HVAC assets.

FIG. 22 is a flowchart depicting a method of communicating information from a mobile survey device to a server, according to one embodiment of the present invention.

FIG. 23 is a flowchart showing a method of identifying an asset within a database or adding the asset to the database, according to one embodiment of the present invention.

FIGS. 24-26 are exemplary screen shots showing portions of the system for identifying an asset or adding an asset to a database, according to one embodiment of the present invention.

### DETAILED DESCRIPTION

The system and method of the present invention is an equipment or asset survey method that can be used to quickly and efficiently survey equipment or assets or any other relevant site characteristics located at one or more sites. Any enterprise with numerous assets or equipment to manage has difficulties in collecting information related to those assets or equipment quickly and economically. The present invention allows such an enterprise to quickly and easily collect information about numerous assets or equipment at one or more sites. The system and method of the present invention allows for simple collection of information for purely information purposes or further for organizing the collected information and uploading it into additional unique systems for further processing as part of an asset management system or other similar systems.

While the system and method of the present invention will be further discussed herein in the context of equipment or asset information collection, the information that can be collected by the present invention is not limited to equipment or asset information. The system and method of the present invention can be used to collect any information of any kind at a site. For example, information to be collected can include systems comprising several pieces of equipment such as refrigeration or electrical circuits or wireless networks. Additionally, information to be collected may include information related to inventories or stocks of materials, signage, furniture, fixtures, or any other physical objects at the site or physical infrastructure related to the site.

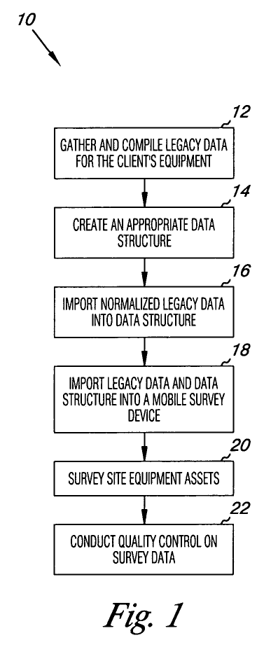

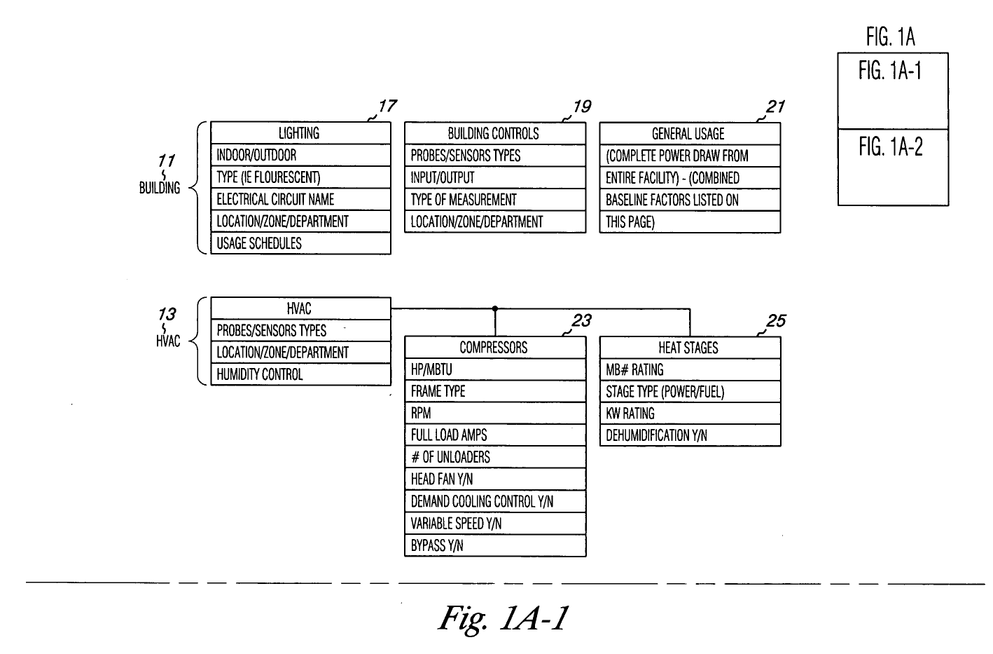

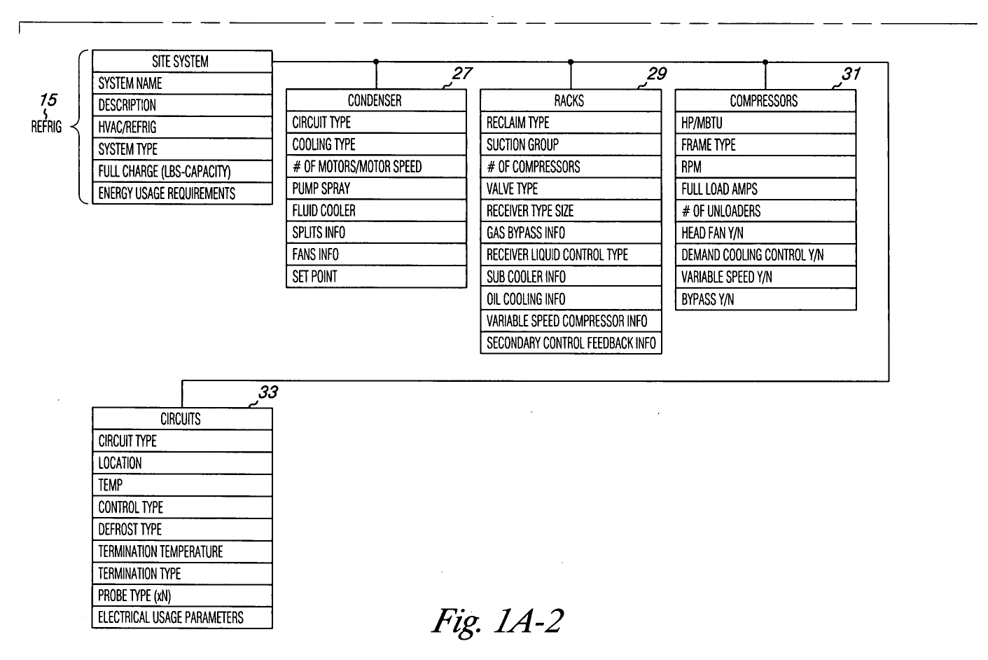

FIG. 1 is a flow chart showing an equipment surveying method 10, according to one embodiment of the present invention. As shown in FIG. 1, the equipment surveying method 10 includes gathering and compiling legacy data for a client's equipment assets (block 12), creating an appropriate data structure for collecting and storing equipment information (block 14), importing normalized legacy data into the data structure (block 16), importing the data structure and the legacy data (block 18), and surveying site equipment assets to collect relevant information (block 20). In one embodiment, a quality control review is conducted on the collected survey data (block 22).

Typically, an enterprise will have some pre-existing legacy data relating to equipment located at its site or various distributed sites. If present, this legacy data is reviewed to establish an appropriate data structure (block 14) for the following survey process. For example, in one embodiment, the data is reviewed to identify exemplary equipment categories and subcategories for inclusion in the data structure. The present invention is flexible and configurable and allows creation of a variety of data structures, as needed. Also, the information or fields gathered for each equipment asset are fully configurable and customizable. The desired fields depend on the goals and objectives of the enterprise. Generally, the more tasks that the enterprise would like to perform, the more fields that are included in the data structure.

For example, if one of the goals of the enterprise is to perform energy management, certain information relevant to energy management is included in the fields specified by the data structure. FIG. 1A is a diagram showing the information collected for various types of equipment, according to one embodiment of the present invention. As shown in FIG. 1A, equipment may be placed into three categories, namely building 11, HVAC 13, and refrigeration 15. The embodiment of FIG. 1A further categorizes building 11 into lighting 17, building controls 19, and general usage 21. As shown, HVAC 13 is further categorized into compressors 23 and heat stages 25, and refrigeration 15 is further categorized into condensers 27, racks 29, compressors 31, and circuits 33. FIG. 1A further shows several example fields of information that may be collected for each type of equipment.

FIG. 1B is a diagram showing the information collected from a site, according to another embodiment of the present invention. As shown in FIG. 1B, information may be placed into three categories, namely site data 35, site photos 37, and equipment data 39. The embodiment of FIG. 1B further shows several example fields of information that may be collected for each category.

Further exemplary fields are disclosed in co-pending U.S. patent application number 10/___,___, entitled “Enterprise Energy Management System,” filed on Jan. 30, 2004, which is incorporated herein by reference in its entirety and claims priority to U.S. provisional patent application No. 60/444,091, filed on Jan. 31, 2003.

According to an alternative aspect of the present invention, the information collected may be any known or collectable equipment information or data of any kind.

Creation of a data structure (block 14) as shown in FIG. 1 further includes, where appropriate, identifying acceptable entries or attributes for a particular field relating to a piece of equipment. In one embodiment, the acceptable attributes are determined by reviewing the legacy data and identifying likely attributes for a site or a set of sites. In another embodiment, the acceptable attributes are set using the knowledge of one skilled in the art. The use of a set of acceptable attributes assures uniformity and consistency of the data, such that the same asset located throughout a set of distributed sites is consistently given the same name and set of descriptions. This approach allows robust and accurate tracking and management of equipment assets.

Once a data structure, including fields of interest and acceptable attributes, is specified, the legacy data (assuming legacy data exists for the enterprise) is imported into this data structure. According to one embodiment, this legacy data can serve as the starting point for the survey process.

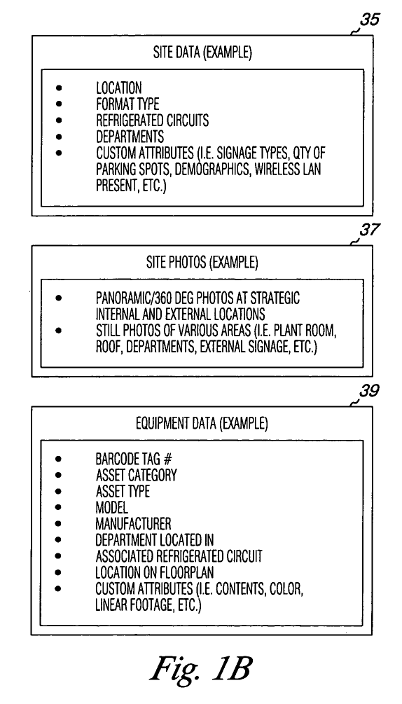

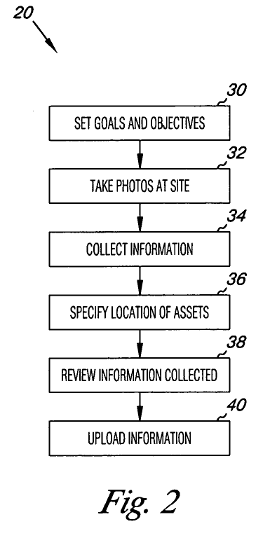

FIG. 2 is a flow chart showing an equipment surveying method using a mobile survey device 20, according to one embodiment of the present invention. As shown in FIG. 2, the equipment surveying method 20 can include setting goals and objectives (block 30), taking photos at the site (block 32), collecting information (block 34), specifying the location of assets at the site (block 36), reviewing the information collected (block 38), and uploading the information (block 40). Alternatively, the method 20 can include any variation of the above steps, including performing only one or two of the steps. According to one embodiment, the step of specifying the location of assets at the site (block 36) includes specifying the asset location by placing a representative electronic object on an electronic floorplan of the site.

FIGS. 2A-9 are exemplary screen shots showing portions of a mobile survey device (block 20), according to one embodiment of the present invention. According to one embodiment, the mobile survey device of the present invention has software allowing for the collection of various types of information. The software can be any software that allows for collection of data, photographic files, audio files; video files, floorplan files, and any other information formats that may be useful for collection of information at one or more sites. In one exemplary embodiment, the mobile survey device has database software allowing for collection of data, photo or other file software allowing for collection of electronic photos, electronic audio files, etc., and design software providing for the capability of setting forth floorplans and allowing for editing of such floorplans. In a further embodiment, the data, photo, and design software are linked to provide associations between various pieces of information across the software applications.

FIG. 2A depicts a portion of the mobile survey device that represents an overview screen or “process guide” 40, according to one embodiment of the present invention. The overview screen can include a location for indicating when various steps of the survey process have been completed at the mobile survey device. According to one embodiment, there is a location for indicating that the user has checked in with the manager 50, taken photos 52, placed assets 54, viewed a site report 56, and uploaded data 58. From the process guide 40, a user can access portions of the device relating to site information 42, photos 44, floor plans 46, and an uploading or “review and submit” portion 48.

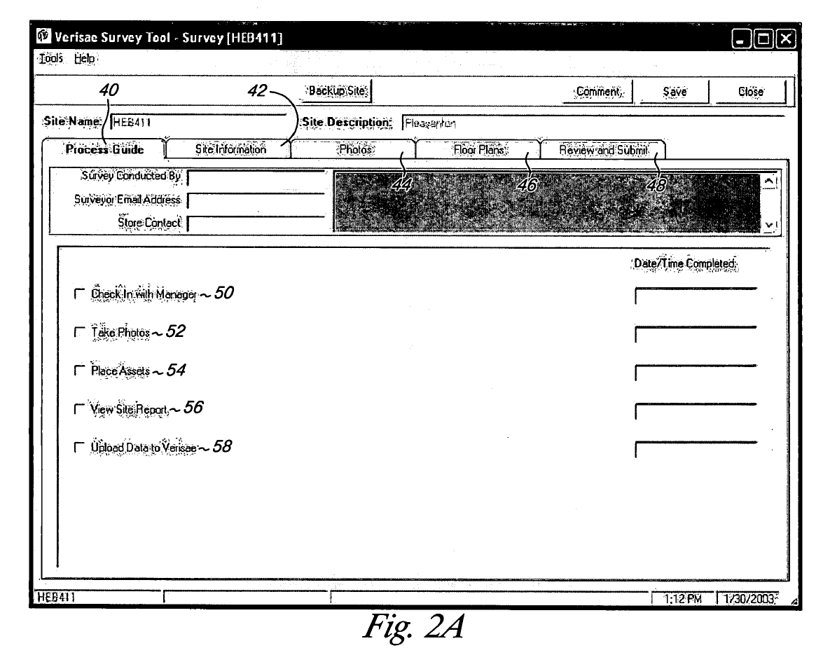

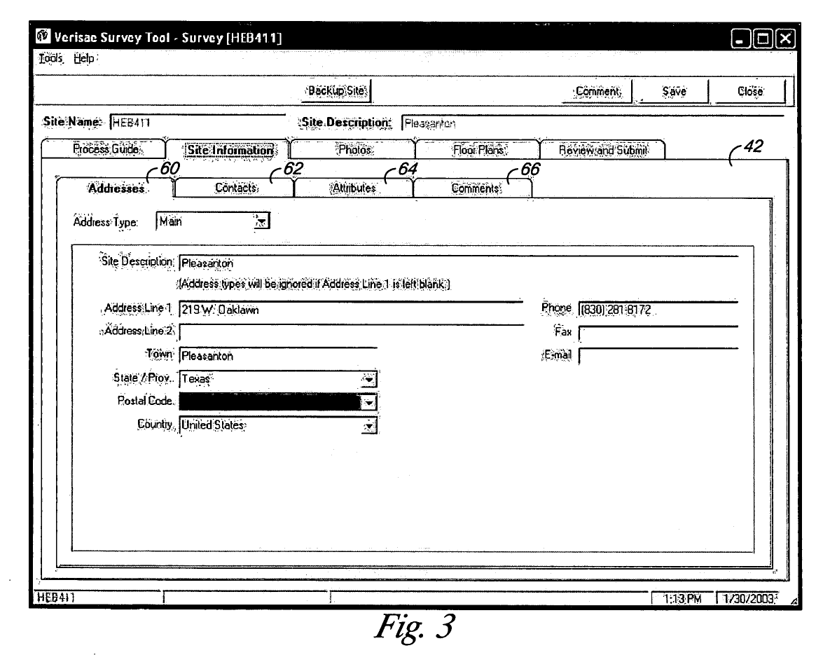

FIG. 3 depicts an exemplary screen shot relating to the site information portion 42, according to one embodiment of the present invention. The site information portion 42 can include site information relating to site addresses 60, site contacts 62, site attributes 64, and comments relating to the site 66. From the site information portion 42, a user can access portions of the device relating to the process guide 40, photos 44, floor plans 46, and the review and submit portion 48.

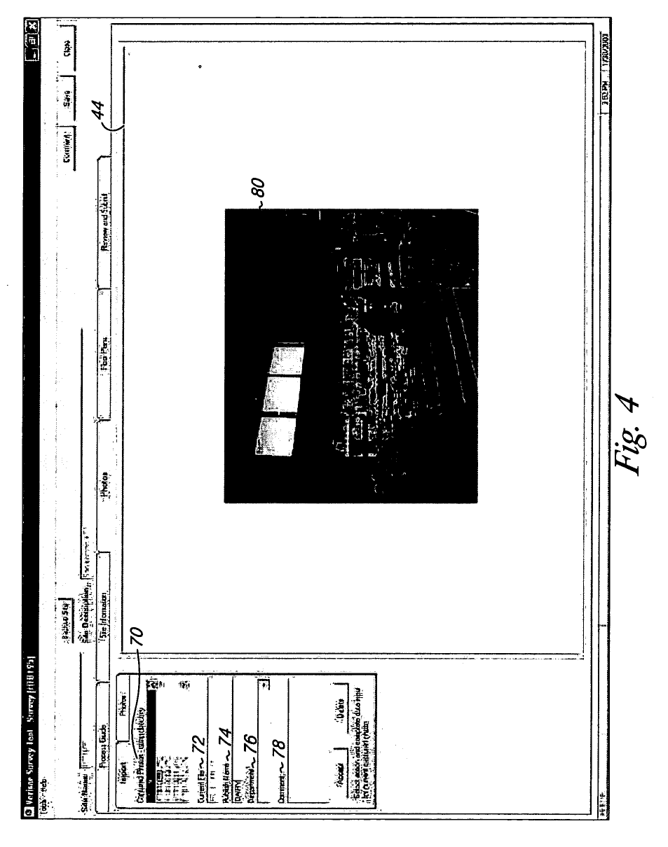

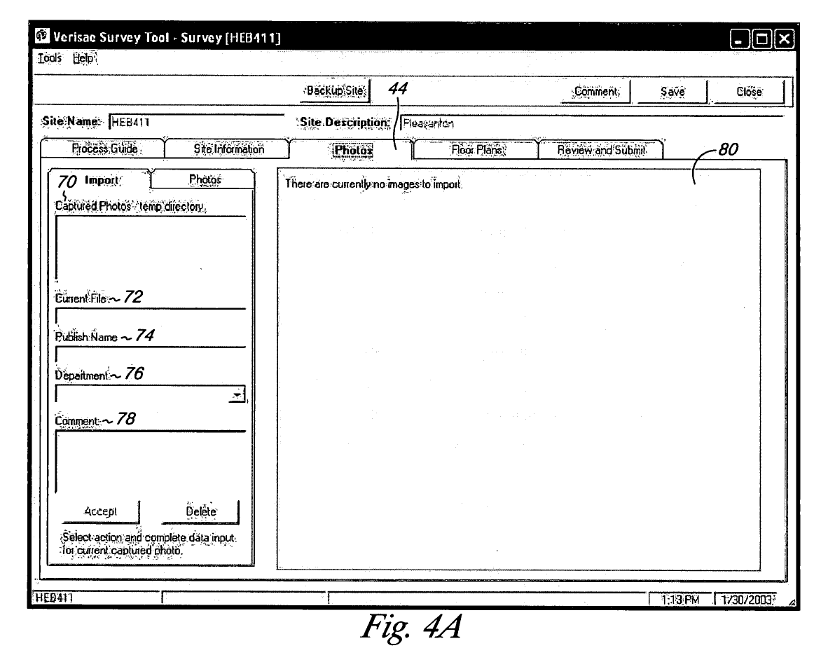

FIG. 4 depicts an exemplary screen shot relating to the site photo collection portion of the device 44, according to one embodiment of the present invention. The site photo collection portion 44 in FIG. 4 represents an exemplary photo collection user interface for facilitating collection of site photos. According to one embodiment, the site photo collection portion includes locations for a directory of captured photos 70, an indicator of the current file being displayed 72, an indicator of the publish name of the file 74, an indicator of the department to which the photo relates 76, a comments section 78, and the displayed photo 80. FIG. 4, as shown, depicts the photo collection portion of the device 44 with a captured photo being displayed. From the photo collection portion 44, a user can access portions of the device relating to the process guide 40, site information 42, floor plans 46, and the review and submit portion 48.

FIG. 4A depicts an exemplary screen shot relating to the site photo collection portion of the device 44, according to an alternative embodiment of the present invention. FIG. 4A, as shown, depicts the photo collection portion of the device 44 with no captured photos available. From the photo collection portion 44, a user can access portions of the device relating to the process guide 40, site information 42, floor plans 46, and the review and submit portion 48.

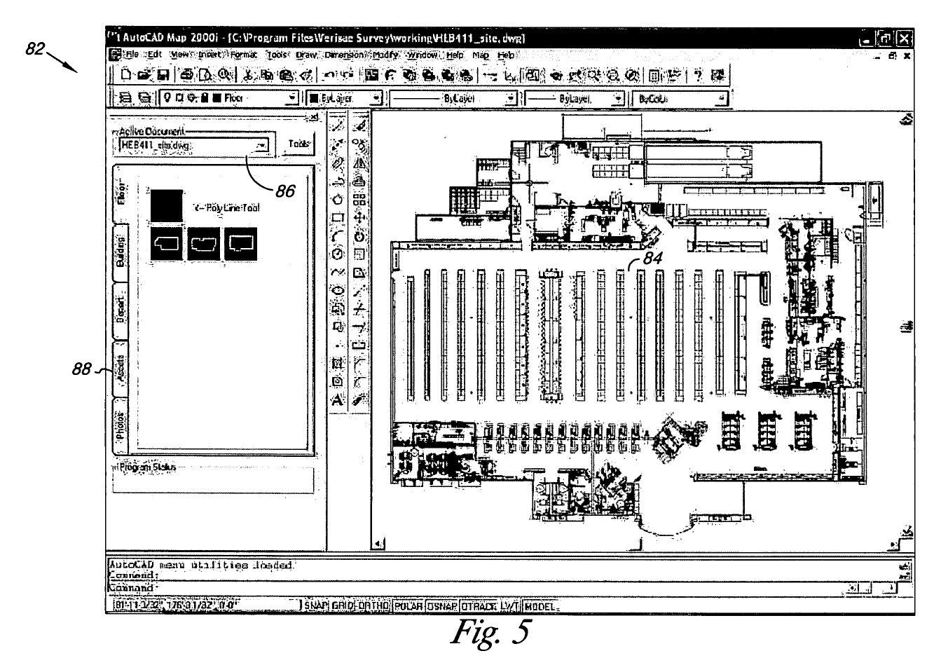

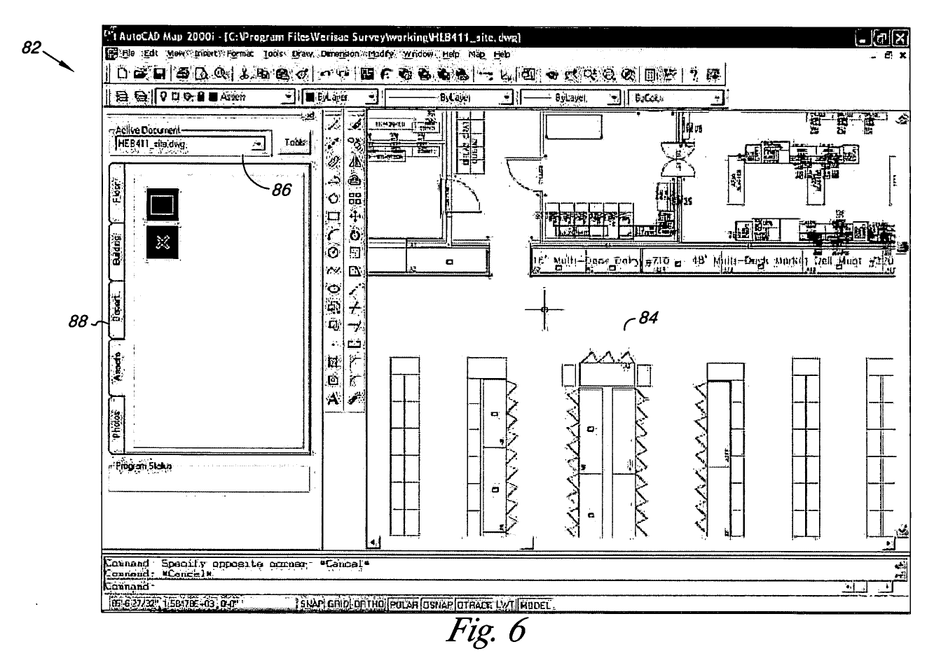

FIGS. 5 and 6 depict exemplary screen shots relating to a floor plan editing portion of the device 82, according to one embodiment of the present invention. The floor plan editing portion 82 can be used in one embodiment to specify the location of a particular piece of equipment. According to one embodiment, the floor plan editing portion 82 includes locations for creating or displaying a floor plan 84, for indicating the current floor plan file being displayed 86, and for selecting various figures, drawing tools, or photos to create the floor plan 88. In accordance with one aspect of the present invention, a user can identify on the floor plan display 84 a representative location where a particular photograph collected with the device at the site was taken and from what angle.

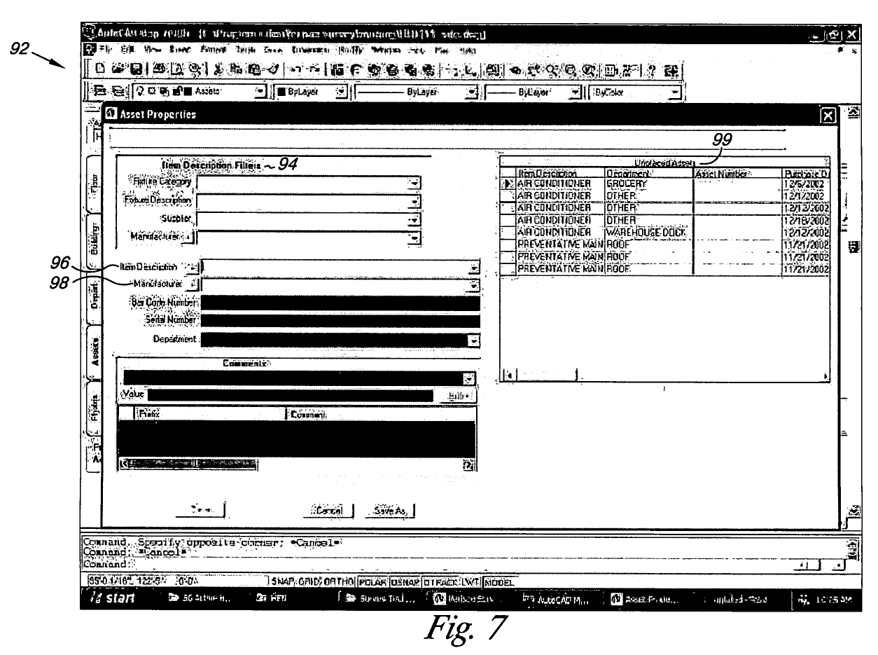

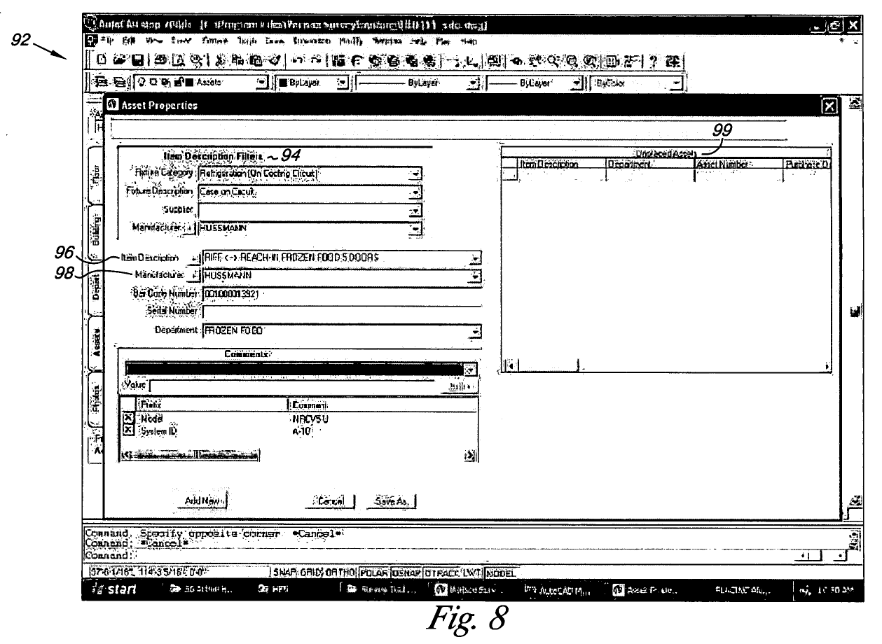

FIGS. 7 and 8 depict exemplary screen shots relating to a equipment information collection portion of the device 92, according to one embodiment of the present invention. The information collection portion 92 can be used according one embodiment to collect information about a specific piece of equipment. According to one embodiment, the information collection portion 92 includes locations for item description filters 94, item descriptions 96, manufacturer descriptions 98, and unplaced asset identification 99. According to one embodiment, the unplaced asset identification list indicates each asset that has been identified but has not yet been placed at its proper representational location on the electronic floor plan. Once an asset is placed, it is removed from the unplaced assets identification list 99. As shown in FIGS. 7 and 8, several fields require input using a drop-down box. These drop-down boxes include the acceptable attributes from which a user selects an appropriate choice. Typically, each drop-down box will include an “other” response, where none of the pre-specified choices are appropriate. This “other” category allows for entry of any information that does not fit within one of the specified choices. Further, this “other” category can allow for variation and adjustment of the data structure as is disclosed further herein.

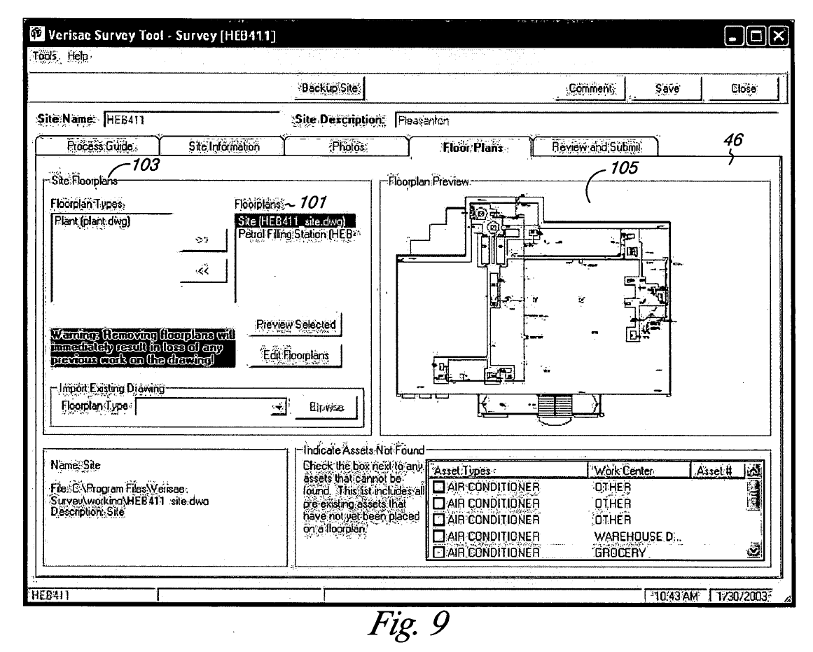

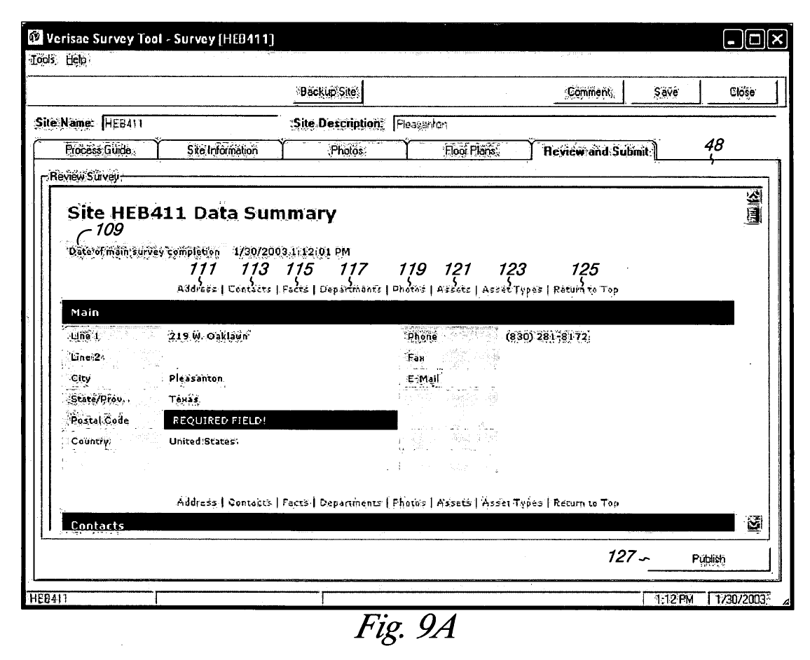

FIG. 9 depicts an exemplary screen shot relating to the floor plan portion of the device 46, according to one embodiment of the present invention. The floor plan portion 46, according to one embodiment, can be used to identify and review various floor plans at a site. According to one embodiment, the floor plan portion includes a list of floor plan files 101, a list of floor plan types 103, and a floor plan display area 105. From the floor plan portion 46, a user can access portions of the device relating to the process guide 40, site information 42, photos 44, and the review and submit portion 48.

FIG. 9A depicts an exemplary screen shot relating to the review and submit portion of the device 48, according to one embodiment of the present invention. The review and submit portion 48, according to one embodiment, can be used to review all of the data and files and any other information collected at a site and then submit the information for transfer to the server. According to one embodiment, the review and submit portion includes a date of main survey completion 109, and a set of buttons for moving through the review and submit portion, including buttons to move to the address portion 111, the contacts area 113, the facts area 115, the departments area 117, the photos area 119, the assets area 121, the asset types area 123, and a button to return to the top of the review and submit portion 125. From the review and submit portion 48, a user can access portions of the device relating to the process guide 40, site information 42, photos 44, and the floor plan portion 46.

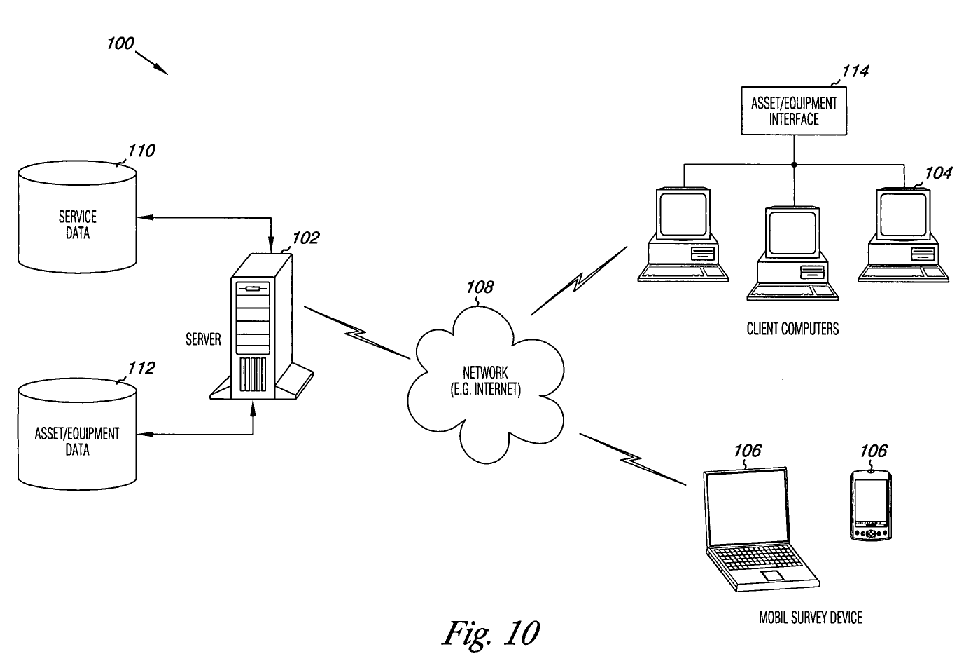

In one embodiment, the method of the present invention is implemented in conjunction with an enterprise asset management system for managing the assets of a distributed enterprise. One example of such a system is disclosed in co-pending U.S. patent application Ser. No. 09/883,779, entitled “Method and System for Managing Enterprise Assets,” filed on Jun. 18, 2001, which is incorporated herein by reference in its entirety. FIG. 10 is a schematic diagram showing a network-based site equipment survey system 100 according to a second embodiment of the present invention. As shown in FIG. 10, the system 100 includes a server 102 in communication with client computers 104 and mobile survey devices 106 through a network 108. The client computers 104 and mobile survey devices 106 may be located at each of the various distributed sites requiring an equipment survey. The system 100 allows a distributed enterprise to conduct surveys at multiple sites.

As further shown in FIG. 10, in one embodiment, the server 102 is in communication with a service database 110 and an asset or equipment database 112. The client computers 104 are in communication with individual pieces of equipment through an asset/equipment interface 114. In one embodiment, the interface 114 includes software to translate and normalize signals received from various types of equipment, such as that disclosed in co-pending U.S. application No. 10/734,725, filed Dec. 12, 2003, which is incorporated herein by reference in its entirety. In one embodiment of the present invention, the system 100 further tracks and manages refrigerant loss in the enterprises various refrigeration circuits, as disclosed in co-pending U.S. application Ser. No. 10/429,619, filed May 5, 2003, which is incorporated herein by reference in its entirety.

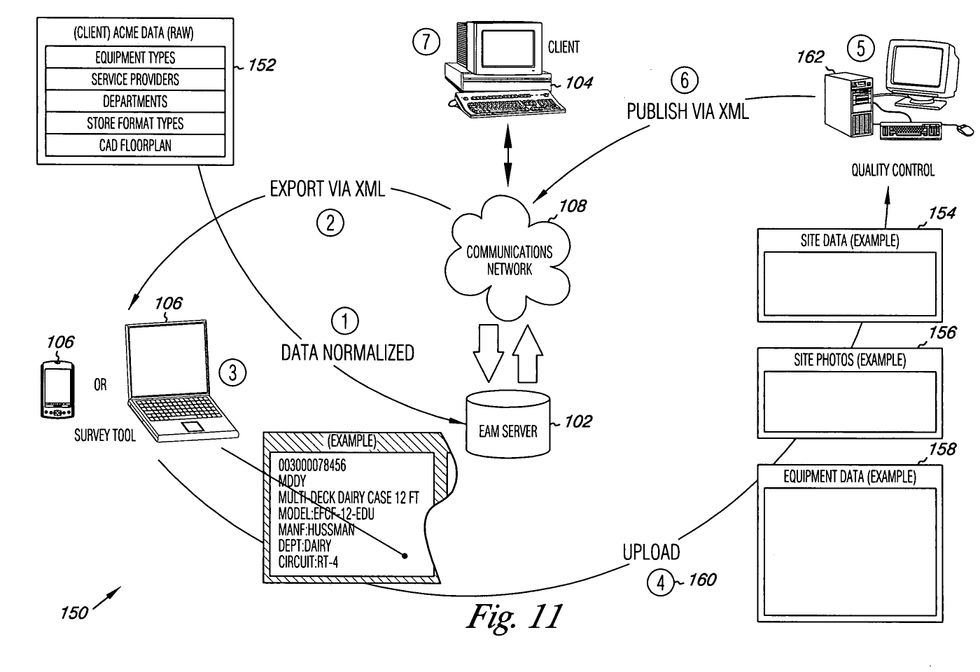

FIG. 11 is a diagram showing a survey process 150 for using the system 100 to conduct a survey of equipment assets located at a site. As shown in FIG. 11, the survey process 150 includes starting with legacy data that relates to a site and was collected from a site 152 prior to the start of the survey process, such as for example, equipment types, service providers, departments or zones, store format types, and CAD floorplans. This legacy data is normalized and imported into the server 102 prior to beginning the survey process. In one embodiment, the legacy data is imported prior to beginning the survey process and then normalized by the server 102. The server 102 then either executes software to create a data structure as specified above, or a user evaluates the data and creates an appropriate structure.

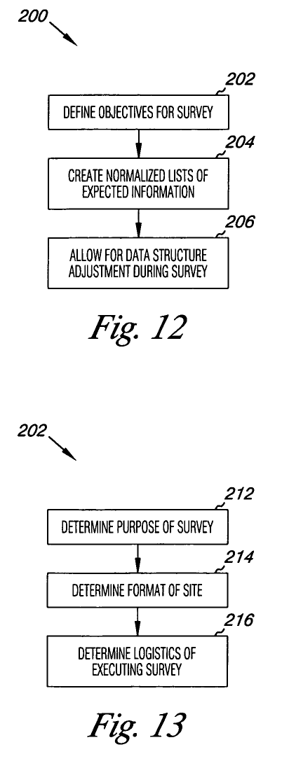

FIG. 12 depicts a method of creating a data structure 200, according to one embodiment of the present invention. The method includes defining survey objectives (block 202), creating normalized lists of expected information (block 204), and allowing for data structure adjustment during the survey process (block 206).

FIG. 13 is a flowchart depicting a method of defining survey objectives (202), according to one aspect of the invention. The process of defining survey objectives can vary significantly depending on the type of survey and the characteristics of the site. According to one embodiment, the process includes determining the purpose of the survey (block 212), determining the format of the site (block 214), and determining the logistics of executing the survey (block 216). Alternatively, there can be other or different steps involved in defining survey objectives.

The process of determining the purpose of the survey (block 212) can vary depending on the desires of the client, the type of site, and any number of other factors. One survey example is an information equipment survey for the simple purpose of determining what pieces of equipment or assets are present at a site or sites. Another example would be an equipment survey in preparation for refurbishment of a site. In this example, it may be helpful to first determine what equipment is present at the site in order to determine, for example, what needs to be refurbished and at what cost. The purposes of the survey can include preparation for significant equipment relocation or for a brand conversion. A brand conversion can include the alteration of signage, fixturing, and other physical objects at the site to address a change in corporate or brand identity. Further, the survey may be an equipment survey at a site scheduled for closing. Alternatively, the survey may be for any additional purpose for collecting equipment or asset information. In a further alternative, the survey may be for any purpose related to collecting information related to any physical objects or physical infrastructure at a site or sites, such as a survey of stocks or inventories of materials such as refrigerants, solvents, or any other inventory or stock materials that may be of interest at a site or sites.

The process of determining the format of the site (block 214) can include determining the physical structure or layout of the site. For example, the site may be a convenience store, a warehouse, or any other type of site. Part of this process can include, according to one embodiment, obtaining any floorplan information related to the site that is available from the client. In a further embodiment of the present invention, the system of the present invention includes obtaining a floorplan in an electronic format or converting the floorplan to an electronic format. The format of the site can be important not only for information purposes, but also because information related to the format of the site can influence expectations related to equipment, location of equipment, amount of equipment, other physical objects of interest, and any expected linkages between equipment and any department or work center associated with the equipment.

The process of determining logistics related to a survey (block 216) is a process of planning for implementation relating to personnel and other survey requirements. According to one embodiment, logistics determination can include the number of people required to perform a survey, the amount of time and expense of transporting the people to the site, the amount of time and expense of performing the survey, and various other pieces of information relating to the execution of the survey. The logistics can vary significantly depending on the enterprise and the site.

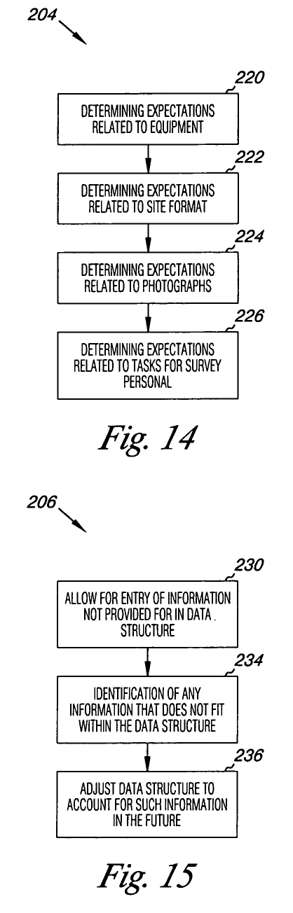

FIG. 14 is a flowchart depicting a method of creating normalized lists of expected information (204), according to one aspect of the invention. The process of creating normalized lists can also vary significantly depending on the type of survey, the characteristics of the site, and various other factors. According to one embodiment, the process includes determining expectations related to equipment (block 220), site format (block 222), photographs (block 224), and tasks for survey personnel (block 226). Alternatively, there can be other or different steps involved in creating normalized lists of expected information.

The process of determining expectations related to equipment (block 220) can include determining and creating a field for any information to be collected related to equipment. Part of this process can include, according to one embodiment, determining the type of equipment expected to be present at the site, including the make, model, categorization as to overall use, and any related characteristics of the equipment, determining the name assigned to the piece of equipment, the location of the equipment at the site, determining the attributes for which to collect information for each piece of equipment, and any other information relevant to the equipment. Other exemplary information that may be relevant to this process includes information relating to refrigeration and HVAC equipment such as EPA classification. Determining information relating to equipment type can be important, because it is possible that the system of the present invention already contains some information relating to certain types of equipment that can be accessed upon identification of the equipment type.

The process of determining expectations related to the site format (block 222) can include determining and creating a field for any information to be collected related to site and any characteristics of interest related to the site. Part of this process can include, according to one embodiment, determining expectations with respect to the type of site, the size of the site, the existence of and number of any departments at the site, the titles or positions of personnel at the site, and any other information of interest relating to site format and site characteristics.

The process of determining expectations related to photographs (block 224) can include determining expectations as to photographs that may be needed or may be of interest relating to the site. Further, the process of determining expectations related to tasks for survey personnel (block 226) can include determining expectations related to any special steps or procedures that should be taken by the survey-taker during the execution of the survey.

FIG. 15 is a flowchart depicting the process of allowing for data structure adjustment during the survey process (206), according to one aspect of the present invention. The process of allowing for data structure adjustment is a process by which the system and method of the present invention provides for flexibility and variability in its data structure. That is, the present invention according to one embodiment allows for adjustment of the data structure during execution of a survey to account for information that was not allowed for in the original data structure. The mobile survey device, according to one embodiment, allows for entry of information that was not provided for in the data structure (block 232). Upon importation of the survey information into the online system, the system automatically identifies any information that does not fit within the pre-established data structure (block 234) and the structure can be adjusted to account for such information going forward in future surveys or further execution of the same survey (block 236).

Once a data structure is created and includes the legacy data, a file is exported to the mobile survey device. The file can be communicated using any known communication technique. In one embodiment, for example, the file is encrypted and posted to an FTP site where a user of the mobile device 106 can access and download the file. The mobile survey device 106 can be any type of device known in the art, such as a notebook computer, a handheld computer, or a personal digital assistant. The mobile survey device 106 can have continuous connectivity to the network (e.g., Internet) using a wireless or a wired technique or can use periodic connectivity as needed.

A user operates the mobile survey device as described to collect information relating to various equipment assets located at the site. In one embodiment, the user first collects general site information, such as that shown in blocks 154 and 156 in FIG. 11. According to one aspect of the invention, for example, a user navigates the site in the following systematic fashion. Upon locating an asset, the user locates the asset on the floor plan using a double-click. This double-click on the floor plan opens a data entry window. The user then places and inputs a barcode number and selects equipment type and any requested categories or sub-categories. The user then enters all other requested information, using a drop-down menu system including pre-specified attributes as specified above. Various examples of information that are collected in one embodiment are shown in FIG. 11. For example, the equipment information (shown in block 158) may include asset category, asset type, model, manufacturer, department, associated refrigeration circuit, location on floor plan, and any other desired attributes. Others skilled in the art will envision other types of information that may be useful as well.

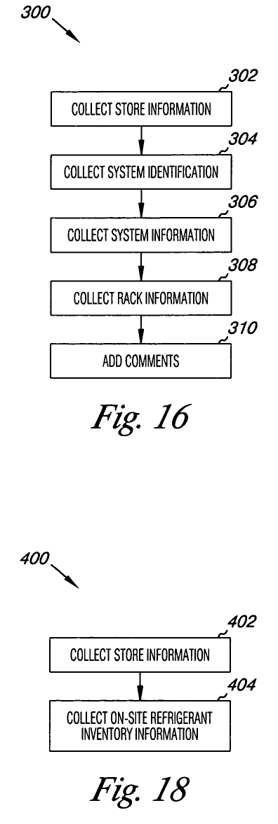

FIG. 16 is a flowchart depicting a method of conducting a survey relating to data associated with refrigeration or HVAC assets for the purposes for refrigerant tracking 300, according to one embodiment of the present invention. The method includes collecting store information (block 302), collecting a system identification (block 304), collecting system information (block 306), and adding comments (block 310). According to one embodiment, the method includes collecting rack information (block 308).

According to one embodiment, the collection of store information can include, but is not limited to, such information as, for example, store number, date, contractor group, technician name, store address, the technician's EPA certification number, and technician phone number. Alternatively, the store information can include any information about the store that is relevant.

According to one aspect of the invention, the collection of system information can include, but is not limited to, such information as, for example, EPA category, charge determination method, full charge capacity, refrigerant type, observed system status, system configuration, system type, onsite charge documentation detail, and system description. According to one embodiment, the charge determination method, which is the method for calculating the charge, can be chosen from four different methods, including (1) onsite charge documentation, (2) calculation, (3) measurement, or (4) manufacturer's information (established range). In one aspect of the invention, the system status can be chosen from (1) normal operation, (2) operating under extension, (3) shutdown, or (4) retrofit in progress.

In one embodiment, the collection of rack information can include, but is not limited to, such information as, for example, rack manufacturer, receiver volume, compressors, and total horsepower.

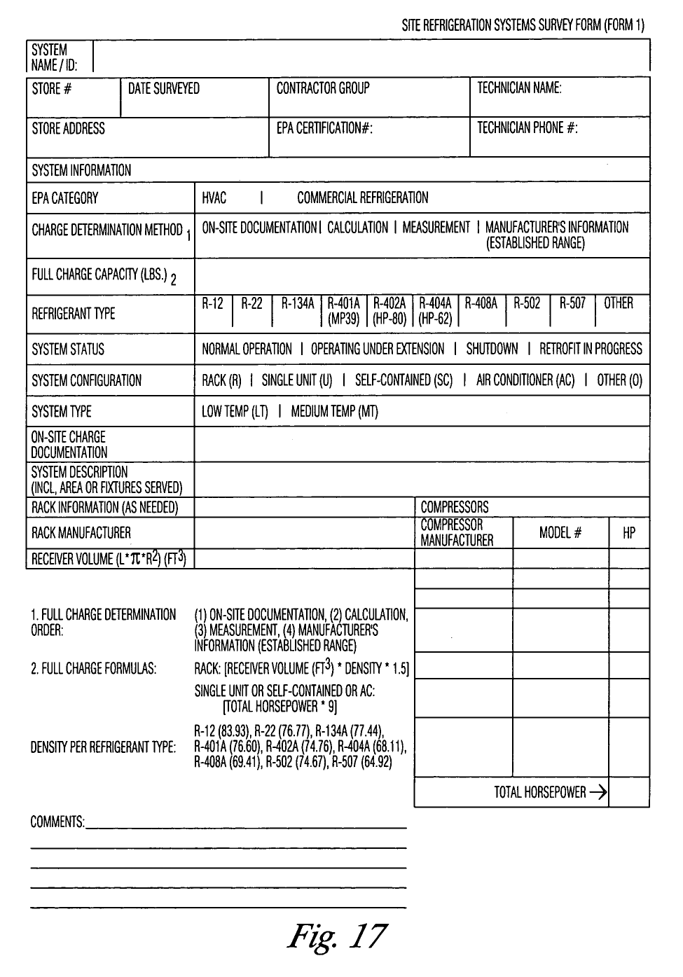

According to one embodiment, the method of conducting a refrigerant tracking survey 300 is performed with the survey tool. Alternatively, the information is collected manually. FIG. 17 is an exemplary depiction of a form that can used for manual collection of the data related to the refrigeration or HVAC assets. Subsequently, the data collected on the form in FIG. 17 can be inputted into the survey tool or into the appropriate application at the server.

FIG. 18 is a flowchart depicting a method of conducting a survey relating to data associated with refrigerant stored in cylinders at a site for the purposes of refrigerant tracking 400, according to one embodiment of the present invention. The method includes collecting store information (block 402) and collecting on-site refrigerant inventory information (block 404).

According to one embodiment, the collection of store information can include, but is not limited to, such information as, for example, store number, date of survey, contractor group, technician name, store address, EPA certification number, and technician phone number. Alternatively, the store information can include any information about the store that is relevant.

According to one aspect of the invention, the collection of on-site refrigerant inventory information can include, but is not limited to, such information as, for example, refrigerant type, whether the refrigerant has been marked as reclaimed, cylinder size, charge remaining in the cylinder, and cylinder identification.

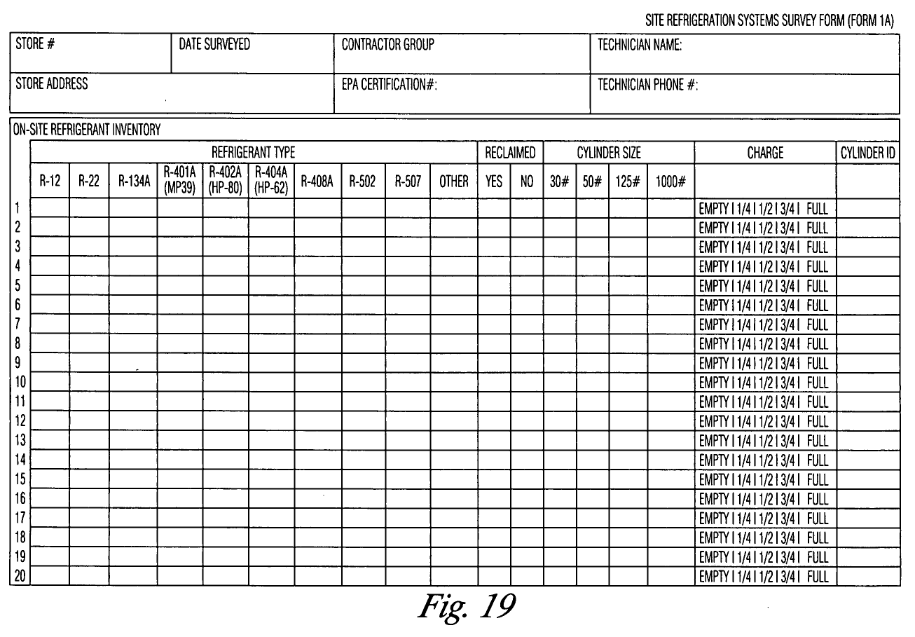

According to one embodiment, the method of conducting a stored refrigerant survey 400 is performed with the survey tool. Alternatively, the information is collected manually. FIG. 19 is an exemplary depiction of a form that can used for manual collection of the data related to the stored refrigerant. Subsequently, the data collected on the form in FIG. 19 can be inputted into the survey tool or into the appropriate application at the server.

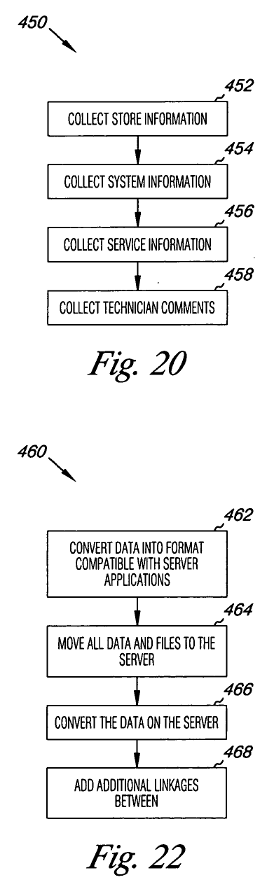

FIG. 20 is a flowchart depicting a method of conducting a survey relating to refrigerant leakage and repair data associated with refrigeration or HVAC assets 450, according to one embodiment of the present invention. The method includes collecting store information (block 452), collecting system information (block 454), collecting service information (block 456), and collecting technician comments (block 458).

According to one embodiment, the collection of store information can include, but is not limited to, such information as, for example, store number, date of survey, technician name, store address, the technician's EPA certification number, and technician phone number. Alternatively, the store information can include any information about the store that is relevant.

According to one aspect of the invention, the collection of system information can include, but is not limited to, such information as, for example, system identification, refrigerant type, and any other relevant system information.

According to one aspect of the invention, the collection of service information can include, but is not limited to, such information as, for example, amount of refrigerant added, amount of refrigerant recovered, date of most recent service, service reference number, leak status (whether the leak is repaired or a repair was attempted).

According to one aspect of the invention, the collection of technician comments can include, but is not limited to, such information as, for example, exact leak location, whether all identified leaks were repaired, method of leak repair verification, whether a return trip is required, and additional comments. The leak repair verification methods include bubble, electronic/ultrasonic, pressure, evacuation, and dye inject.

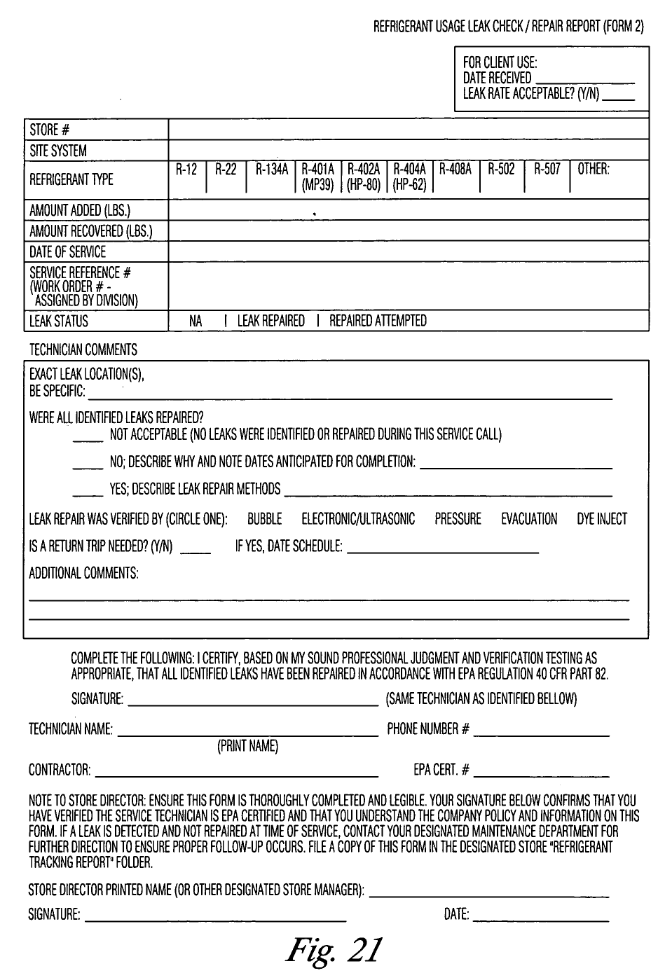

According to one embodiment, the method of conducting a refrigerant leakage and repair survey 450 is performed with the survey tool. Alternatively, the information is collected manually. FIG. 21 is an exemplary depiction of a form that can used for manual collection of the data related to the leakage and repair data. Subsequently, the data collected on the form in FIG. 21 can be inputted into the survey tool or into the appropriate application at the server.

Once the survey process is complete, a file is created and uploaded 160 to a quality control point 162. According to one embodiment, quality control allows for determining whether all information collection has been successfully completed, or whether further information collection is required. For example, if collected information relates to the wrong equipment or is faulty in some fashion, the quality control point allows for identifying these collection failures while survey collectors are still at the site or within a reasonable distance of the site and further allows for instructing the collector to remedy the failure.

According to one aspect of the invention, the quality control process may involve assigning all “other” or “unknown” choices to an appropriate attribute. Where necessary, this process may include adding new allowable attributes to the pre-specified data structure. Alternatively, no quality control is performed.

After quality control is completed, the survey data is communicated via the network 108 to the server 102 for further processing using the techniques described in the various applications which are incorporated herein. This communication to the server is the process of making the information available to the various applications. FIG. 22 is a flowchart depicting a method of communicating the information to the server 460, according to one embodiment of the present invention. The method includes converting the data into a format compatible with the applications at the server (block 462), transferring the data and files to the server (block 464), further converting the data at the server (block 466), and adding additional linkages between imported data and data already available at the server (block 468).

In one aspect of the invention, the mobile survey device has applications that are different than or formatted differently than the applications at the server. Thus, some or all of the information at the device must be re-formatted prior to uploading or importing to the server. Given that the mobile device, according to one embodiment, creates linkages between the information in the various applications during collection of information, the conversion and data transfer process of the present invention occurs such that such linkages are not lost. Alternatively, certain of the applications at the device have the same format as the correlating applications at the server, and no re-formatting is required. According to a further alternative embodiment, the data applications at the device and the service have different formats, while the photo and audio file applications have the same format.

In an embodiment in which the data applications are different but the file applications are the same, the data is converted into a format compatible with the server applications (block 462). The data applications include any database application and any design application. In one exemplary embodiment, the database application at the device is Microsoft Access and the application at the server is Oracle. According to one embodiment, the conversion is a two-step process. First, the database data in the Access format is first converted to the XML format. This step includes an automatic database mapping step—wherein the data is identified by field and thus can be transferred to the appropriate field in the server application—because the format of an XML file inherently organizes data such that it is labeled with its intended use.

In a further exemplary embodiment, the design application at the device uses .dwg files and the application at the server uses .mwf files. The conversion process takes place by a known conversion process in which the .dwg file is converted into a .mwf file. Any linkages created at the mobile device are retained during the conversion using, according to this embodiment, an application called Autodesk Map.

After conversion (block 462), the converted data and files are transferred to the server (block 464). According to this embodiment, the files are transferred without conversion because the file applications in the device and the server are compatible. Alternatively, the applications may not be compatible and then conversion would be necessary.

After transferring the data to the server, a further conversion process may be required (block 466) according to one embodiment of the present invention. For example, if the database data has been converted to an XML file as described above and the server database software is Oracle, the XML file must be converted to a format compatible with Oracle. Alternatively, the data is compatible with the applications at the server upon being moved from the device and no conversion is necessary.

In one alternative aspect of the present invention, once the information is transferred into the server, that information can be linked to information that already existed within the server (block 468). This can be accomplished by any known method for linking information.

In one embodiment, the first step executed by the mobile survey device 106 in collecting information specified to a particular asset, is to check whether the asset is included in the legacy data. This will facilitate data collection and maximize the use of any legacy or pre-existing data.

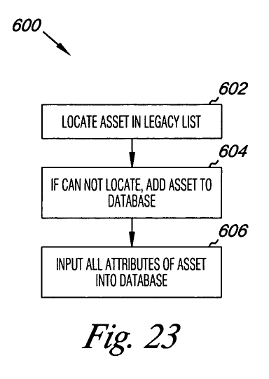

FIG. 23 is a flowchart depicting a method of identifying an asset within a database or adding the asset to the database 600, according to one embodiment of the present invention. The method can include identifying the asset in the legacy list (block 602), and if the asset is not in the legacy list, adding the asset to the database (block 604). The method further includes inputting or reviewing all attributes of the asset (block 606).

According to one embodiment, the step of identifying the asset in the legacy list 602 can include performing a filter. That is, the user inputs any identification that will reduce the number of possible choices presented by the system of the present invention. For example, the filter may be performed by inputting the model number of an asset into the system, which causes the system to present a list of choices, and then the correct asset can be chosen from that filtered list, thereby locating the asset within the database. Alternatively, the filtering step can occur by inputting any other or additional relevant information, such as a model identification, a serial number, a department identification, a manufacturer, a supplier, etc., that will allow for identifying the asset. In a further alternative, no filter step is required and an appropriate informational input automatically identifies the asset.

Regardless of whether a filter is performed, the asset must be identified 602. The identification step can include reviewing the legacy data to ensure that the correct asset has been identified.

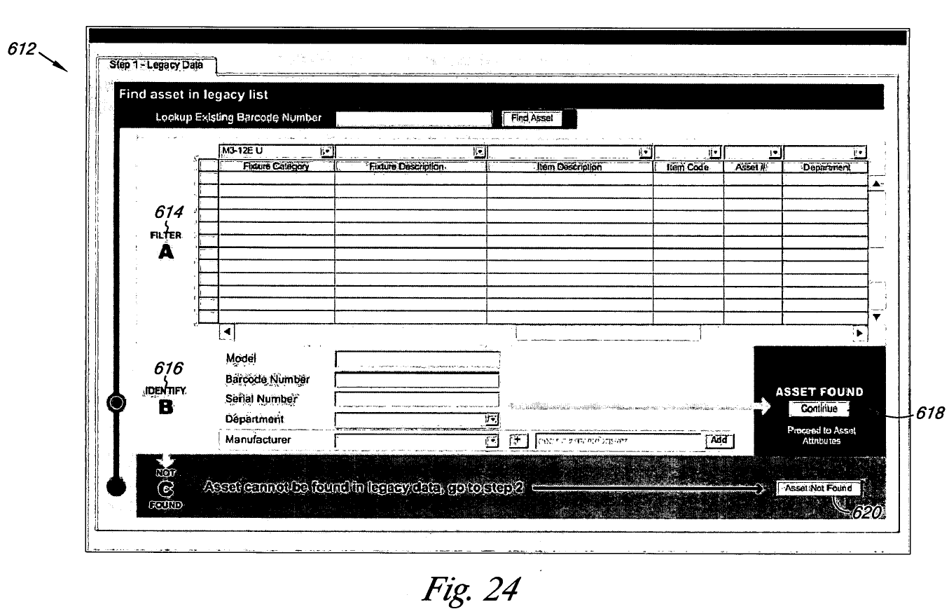

FIG. 24 is an exemplary screen shot relating to a portion of the system providing for locating an asset in a legacy list 612, according to one embodiment of the present invention. The asset location portion 612 of the system can be used to locate an asset in a legacy list as described in FIG. 23. Alternatively, the asset location portion 612 can be used in any way that provides for locating an asset. The asset location portion 612, according to one embodiment, includes a filter portion 614 for performing the filter, a identification portion 616 for performing the identification of the asset, and a continue button 618 if the asset is identified or a button to press if the asset is not found 620.

Returning to FIG. 23, if the asset cannot be found in the legacy data, then the asset must be added to the database 604. To add the asset 604, according to one aspect of the invention, the asset is categorized and then identified. The categorization step can include a description of the category of the asset and a description of the asset. The identification step can include identification of such characteristics as the model, barcode number, serial number, department, and manufacturer of the asset. Alternatively, the identification step can include identification of any relevant characteristic of the asset.

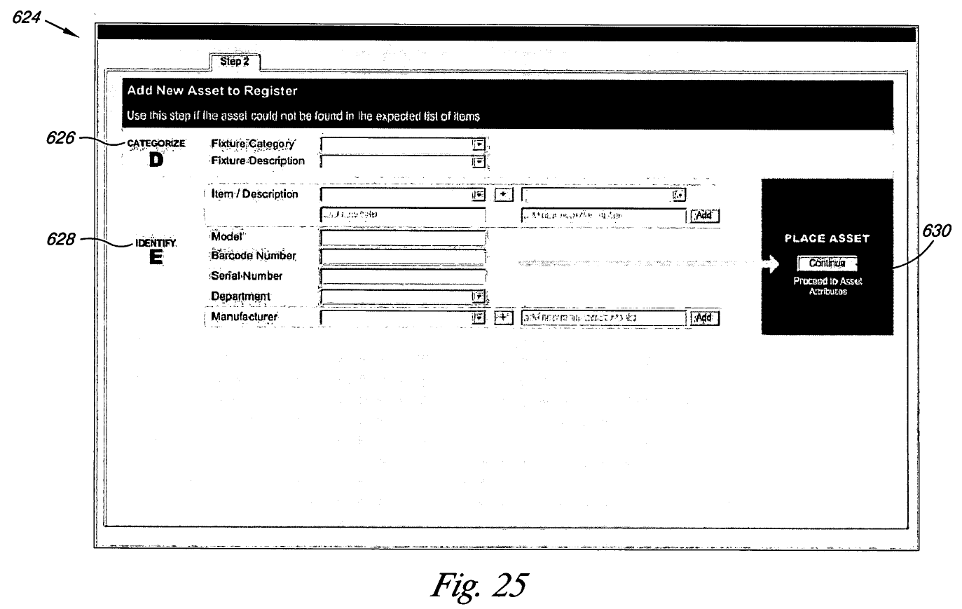

FIG. 25 is an exemplary screen shot relating to a portion of the system providing for adding a new asset to the database 624, according to one embodiment of the present invention. The asset addition portion 624 of the system can be used to add an asset to the database as described in FIG. 23. Alternatively, the asset addition portion 624 can be used in any way that provides for adding an asset. The asset addition portion 624, according to one embodiment, includes a categorization portion 626, an identification portion 628, and a continue button 630 to proceed to the next portion of the system when the addition is complete.

Returning to FIG. 23, once the asset is found or added, then all attributes of asset must be inputted into the database 606. According to one embodiment, the attributes are all characteristics of the asset that are unique to that specific asset. For example, attribute categories that might be inputted include color, condition, dimensions, components, or any other type of attribute that is unique to that specific asset.

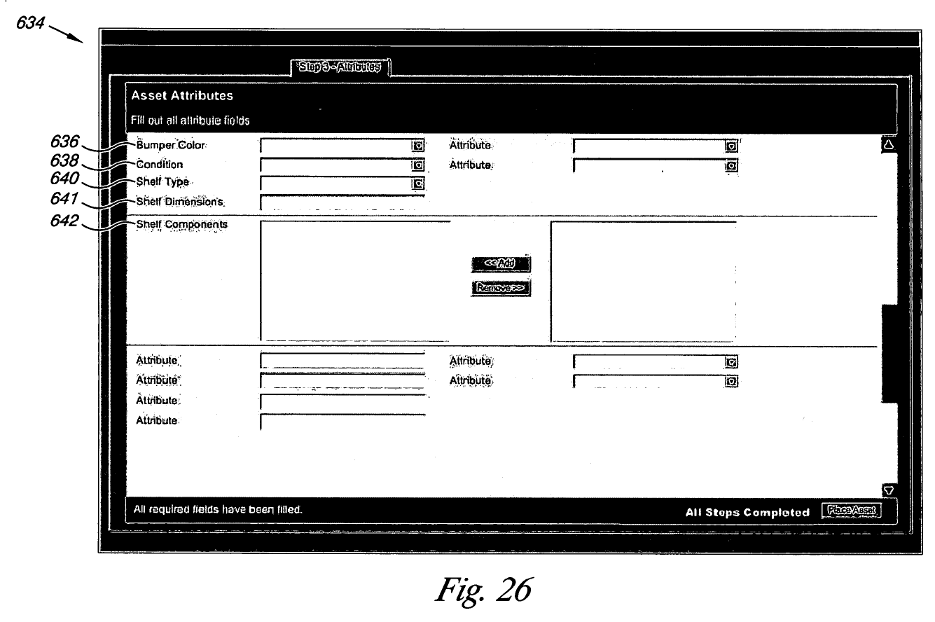

FIG. 26 is an exemplary screen shot relating to a portion of the system providing for inputting attributes of an asset to the database 634, according to one embodiment of the present invention. The attribute input portion 634 of the system can be used to input attributes of an asset to the database as described in FIG. 23. Alternatively, the attribute input portion 634 can be used in any way that provides for inputting attributes of an asset. The asset attribute addition portion 634, according to one embodiment, includes fields for inputting information relating to color 636, condition 638, shelf type 640, shelf dimensions 641, and shelf components 642, along with additional fields for additional attributes.

Although the present invention has been described with reference to preferred embodiments, persons skilled in the art will recognize that changes may be made in form and detail without departing from the spirit and scope of the invention.

We claim:

1. A system for collecting information relating to equipment located at a site, the system comprising:
a first database including legacy data relating to at least a portion of the equipment;
a server including software for importing the legacy data into a specified data structure and for exporting the specified data structure and a survey process; and
a mobile survey device for receiving the specified data structure and the survey process and for guiding a user in collecting the information;
wherein the specified data structure includes a set of equipment categories and a set of attributes relating to each category.

2. A method of surveying equipment assets located at a site, the method comprising:
gathering and compiling any legacy data relating to equipment at a site;
creating an equipment asset data structure based on this legacy data and the goals and objectives of the enterprise;
converting the legacy data into a format consistent with the data structure;
communicating this data structure, including the legacy data, to a mobile survey device.
operating the mobile survey device to survey the equipment assets located at the site and create a site equipment database.

3. The method of claim 2 further comprising communicating the site equipment database to a central server for further processing.

4. The method of claim 3 wherein the further processing includes performing a quality control review of the site equipment database.

5. The method of claim 4 wherein the data structure is communicated as an XML file.
